(19) United States
(12) Patent Application Publication
(10) Pub. No.: US 2018/0362897 A1
(43) Pub. Date: Dec. 20, 2018

(54) WASHING LIQUID AND WASHING METHOD FOR GLASS POLISHING DEVICE

(71) Applicant: PANASONIC INTELLECTUAL PROPERTY MANAGEMENT CO., LTD., Osaka (JP)

(72) Inventors: Haruka NISHIKAWA, Aichi (JP); Toshiyuki IEDA, Ishikawa (JP); Kazuya SHIMADA, Aichi (JP)

(73) Assignee: PANASONIC INTELLECTUAL PROPERTY MANAGEMENT CO., LTD., Osaka (JP)

(21) Appl. No.: 15/781,421

(22) PCT Filed: Jun. 16, 2015
(86) PCT No.: PCT/JP2015/003011

§ 371 Date: Jun. 4, 2018

(30) Foreign Application Priority Data
Mar. 25, 2015 (JP) 2015-063097

(51) Int. Cl. C11D 7/10; B08B 9/08; B08B 9/027; B08B 3/08; C11D 17/08

(52) U.S. Cl. CPC C11D 7/10; B08B 9/08; B08B 9/027; B08B 2209/027; C11D 17/08; B08B 2209/08; B08B 3/08

(57) ABSTRACT

When an alkali-free glass is polished with a polishing liquid containing hydrofluoric acid as a main component, a sludge is generated on a glass surface and in a storage unit and a pipe of a polishing device. As a result, there arise problems such as deterioration of quality and stopping of the device. A washing liquid that dissolves a sludge containing aluminum and fluorine produced in a glass polishing device is characterized by containing Al3+ ions, and a sludge formed by bonding a divalent element such as Mg, Ca, Sr, and Ba with Al and F can be dissolved with this washing liquid. The problems are solved by washing the inside of the polishing device with this washing liquid.

### FIELD

The present invention relates to a washing liquid used in washing of a polishing device for polishing a glass containing Al as a component, and particularly an alkali-free glass, using a polishing liquid containing hydrofluoric acid, and a washing method.

### BACKGROUND

In recent years, a liquid crystal display device has been often used for products such as a mobile phone, a smartphone, a tablet-type personal computer, and a laptop personal computer. The The liquid crystal display device requires glasses having a thickness in a certain extent to hold a liquid crystal between the glasses. However, after the liquid crystal is enclosed between the the glasses, the lighter the liquid crystal display device is made, the lighter a product using the liquid crystal display device can also be made.

Therefore, the glasses between which the liquid crystal is enclosed are polished to be made thin. Thus, the liquid crystal display is made lighter. In this case, the polishing is performed by etching with an etchant in order to secure transparency of the glasses. This is because chemical etching has better polishing rate, plate thickness precision, and surface flatness than mechanical polishing.

The liquid crystal display device in which a glass portion is polished to be made thin has a problem of a decrease in strength of the glass portion. In particular, an apparatus used around the head of a person, such as a mobile phone and a smartphone, requires a glass strength that is equal to or more than a certain strength. As a glass for such an application, a soda glass generally used for a window glass or the like is not used, but an alkali-free glass in which boric acid and alumina are contained is used. Therefore, in the liquid crystal display device of the products described above, above, the alkali-free glass is polished (etched).

The alkali-free glass is polished with an etchant containing hydrofluoric acid (hereinafter also referred to as a “polishing liquid”). In this case, an unwanted solid material (hereinafter also referred to as “sludge”) that does not contribute to polishing is known to be generated in the polishing liquid.

When a large amount of glass is polished, the polishing liquid is often used with circulating and filtering. If this sludge is mixed in the polishing liquid and remains, there is a problem in which the sludge is attached to a glass surface and irregularities are formed on the glass surface after polishing. At a production process, problems such as clogging of a filter and an increase in filtration time arise during filtration of the circulated polishing liquid.

As a countermeasure against the problems, Patent Literature 1 discloses an etching device provided with a sludge treatment unit in communication with an etching tank for performing etching (polishing). The sludge treatment unit has a configuration including a precipitation tank and an acid supply unit. In Patent Literature 1, the sludge is a compound in which silicon separated from a glass and hydrofluoric acid are bonded (H₂SiF₆), and is precipitated once in the precipitation tank. After that, this sludge is dissolved with an acid supplied from the acid supply unit, and removed.

In Patent Literature 2, in a case of glass of a composition having a low BaO content, it is said that there are problems in which production of a gelled compound containing fluorine, aluminum, magnesium, and calcium in an etchant results in an increase in the viscosity of the etchant, clogging at a filtration process for circulation, and solidification of the compound in a pipe and a tank. Further, Patent Literature 2 discloses that mixing of a barium compound in the etchant suppresses the production of such a gelled compound.

### CITATION LIST

### Patent Literature

Patent Literature 1: Japanese Patent Application Laid-Open No. 2008-066706

Patent Literature 2: Japanese Patent Application Laid-Open No. 2003-313049

### SUMMARY

### Technical Problem

A sludge generated in a polishing device accumulates in a pipe and a liquid tank. As a result, transportation of a polishing liquid liquid in the polishing device is prevented, and operation of the device is thus prevented. In particular, when a spray nozzle of the polishing device is clogged with the sludge, the polishing liquid cannot be uniformly supplied to a glass, which generates a portion where polishing is insufficient. When the sludge that is mixed and remains in the polishing liquid comes into contact with the glass, the sludge is fixed to a glass surface to cause deterioration of quality of a product. Therefore, in the polishing polishing device for a glass, the sludge needs to be removed by washing every predetermined period.

In Patent Literature 1, the sludge in an etchant used in circulation is tried to be removed. In Patent Literature 1, the sludge is the compound (H₂SiF₆) in which silicon separated from a glass and hydrofluoric acid are bonded. However, as shown in Examples described below, a sludge generated in polishing of an alkali-free glass was not H₂SiF₆.

Further, it is said that the sludge deposited in the precipitation tank is dissolved with nitric acid or hydrochloric acid. However, a sludge caused from an alumino-borosilicate glass is only slightly dissolved with hydrochloric acid, and hydrochloric acid is not satisfied as a washing liquid.

Patent Literature 2 specifies an alumino-borosilicate glass as a subject of etching, and therefore, clearly shows that the gelled gelled compound contains fluorine, aluminum, magnesium, and calcium. calcium. However, Patent Literature 2 is an invention of suppressing generation of the sludge, and does not disclose a washing liquid of dissolving a sludge that is produced once.

Accordingly, a washing liquid capable of effectively decomposing and washing the sludge produced during polishing of an alkali-free glass with hydrogen fluoride has not been known.

### Solution to Problem

The present invention is made in view of the problems. The present invention provides a washing liquid capable of decomposing a sludge generated during polishing of an alkali-free glass and a method of washing a polishing device.

More specifically, the washing liquid according to the present invention is a washing liquid for dissolving a sludge containing aluminum and fluorine produced in a glass polishing device and is characterized by containing Al³⁺ ions.

The washing method according to the present invention is a method of washing a glass polishing device, the method being characterized by including:

a liquid removing step of drawing a polishing liquid from the polishing device;

an injection step of injecting a washing liquid containing an Al³⁺ ion supplying agent into the polishing device;

a washing step of washing the polishing device with the washing liquid; and

a liquid discharging step of drawing the washing liquid from the polishing device.

### Advantageous Effects of Invention

The washing liquid of the present invention is capable of effectively dissolving the sludge generated in the glass polishing device (in particular, a polishing device for polishing an alkali-free glass). Therefore, the sludge that is deposited and fixed in a pipe and a liquid tank of the polishing device can be removed. As a result, the polishing device can be normally operated, operated, and a yield of glass to be polished is increased.

### BRIEF DESCRIPTION OF DRAWINGS

FIG. 1 is a view illustrating a configuration of a glass polishing device.

FIG. 2 is a graph showing a relationship between a hydrochloric acid concentration and an eluted fluorine concentration.

FIG. 3 is a graph showing a relationship between Al³⁺ concentration and concentration depending on a form of Al as a result of calculation.

FIG. 4 is a graph showing a relationship between an aluminum chloride concentration and an eluted fluorine concentration.

FIG. 5 is a graph showing the sludge dissolution rate and the amount of aluminum chloride and those of a substance in which EDTA is added to aluminum chloride.

FIG. 6 is a view schematically showing a mechanism in which a sludge is dissolved by the presence of Al³⁺.

FIG. 7 is a graph showing a relationship between the elution amount of Ca ions and a time with respect to aluminum chloride, aluminum nitrate, and aluminum sulfate.

FIG. 8 is a graph showing a relationship between the elution amount of Ba ions and a time with respect to aluminum chloride, aluminum nitrate, and aluminum sulfate.

FIG. 9 is a graph showing a relationship between the elution amount of Mg ions and a time with respect to aluminum chloride, aluminum nitrate, and aluminum sulfate.

FIG. 10 is a graph showing a relationship between the elution amount of Sr ions and a time with respect to aluminum chloride, aluminum nitrate, and aluminum sulfate.

### DESCRIPTION OF EMBODIMENTS

Hereinafter, a glass polishing method and a polishing device in relation to the present invention will be described. The following description shows one embodiment of the present invention, invention, and the following embodiment and Examples may be modified modified without departing from the spirit of the present invention. invention.

A subject to be polished by the glass polishing method and the polishing device in relation to the present invention is an alkali-free glass. More specifically, the alkali-free glass contains SiO₂ as a main component and Al₂O₃, B₂O₃, BaO, CaO, MgO, and SrO, and has a high tensile strength and a high softening point. A polishing liquid contains hydrofluoric acid as a main component, and an inorganic acid such as hydrofluoric acid, nitric acid, and sulfuric acid. In addition to these, the polishing liquid may contain an additive such as a surfactant, a defoaming agent, and a chelating agent in some cases.

The inventor of the present application has confirmed, by the following procedure, that a sludge generated during polishing of the alkali-free glass contains a compound of Sr, Al, and F (Sr—Al—F deposit), a compound of Ca, Al, and F (Ca—Al—F deposit), a compound of Mg, Al, and F (Mg—Al—F deposit), and a compound of Ba, Al, and F (Ba—Al—F deposit).

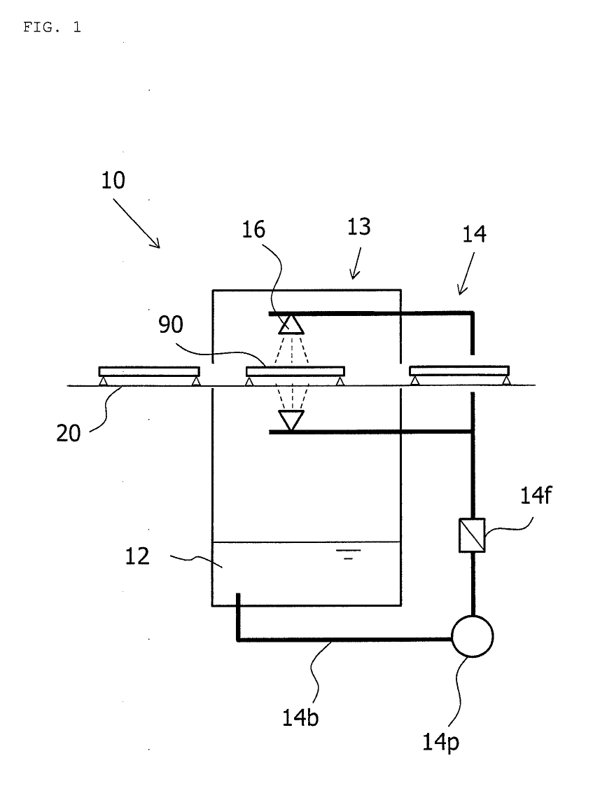

A process of the glass polishing device will be simply described. FIG. 1 illustrates a configuration of a device for polishing the alkali-free glass. A polishing device 10 has a transporting means 20 that transports a glass, a storage unit 12 that stores a polishing liquid, and a shower unit 14 that sucks the polishing liquid from the storage unit 12 and sprays the polishing liquid on a glass 90 to perform polishing.

The shower unit 14 includes a pipe 14b for transferring the polishing liquid from the storage unit 12 to the transporting means 20 and a pump 14p. A nozzle 16 of the shower unit 14 is provided above the storage unit 12. The polishing liquid sprayed on the glass 90 falls into the storage unit 12 as it is. By such a configuration, the polishing liquid is used in a circulating manner.

When the glass 90 is polished, a sludge is generated in the polishing liquid in the storage unit 12, and the polishing liquid becomes clouded. This sludge is filtered out through a filter 14f and mostly removed from the polishing liquid. The sludge collected collected by this filter 14f is dried to yield a white powder. Over time, the white powder is fixed to each part of the polishing device 10. This white powder is referred to as sludge.

The quantitative analysis of this powdered sludge was performed using an energy dispersive X-ray spectrometry (hereinafter referred to as “EDX”), and the qualitative analysis was performed by X-ray diffraction (XRD) analysis.

The polishing device is used to polish the alkali-free glass, but the alkali-free glass as the subject to be polished may have different composition. Therefore, of the alkali-free glass, two kinds of glass having a comparatively high Ba content (hereinafter, referred to as “Ba rich glass”) and glass having a comparatively high Sr content (hereinafter, referred to as “Sr rich glass”) were dissolved with the polishing liquid. A sludge generated from each alkali-free glass was analyzed by the above-described processes.

From the results, MgAlF₅.2H₂O, Mg(AlF₄)₂.2H₂O, and Ca_{0.13}Sr_{0.56}Ba_{0.31}AlF₅ were confirmed as the sludge generated from the Ba rich glass. Further, MgAlF₅.2H₂O, Mg(AlF₄)₂.2H₂O, and SrAlF₄.H₂O were confirmed as the sludge generated from the Sr rich glass. From these results, the white powdered sludge was a substance obtained by bonding an anionic Al—F complex to a divalent element such as Sr, Ca, Mg, and Ba, followed by solidification.

Such a sludge is formed by solidification in a strongly acidic polishing liquid that is a mixed liquid of hydrogen fluoride and inorganic acid, and is not easily removed. Conventionally, the sludge was removed using hydrochloric acid.

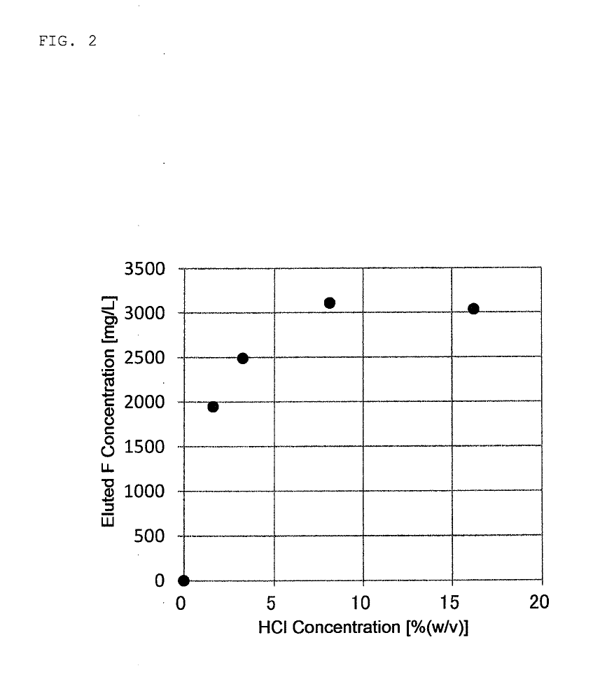

A graph of FIG. 2 shows a relationship between the concentrations of hydrochloric acid and fluorine ions eluted from the sludge. 1.0 g of the sludge from the Sr rich glass was impregnated with 20 mL of hydrochloric acid with a concentration of 0 to 16 [% w/v], and the mixture was stirred for 12 hours while the liquid temperature was held at 30° C. The hydrochloric acid after the stirring was filtered through a filter of 0.22 μm, and the composition of the filtrate was analyzed. For the determination of fluorine, ion chromatography was used, and for other substances, ICP-AES was used.

In FIG. 2, a vertical axis represents the eluted fluorine concentration (in the drawing, represented by “Eluted F Concentration [mg/L]”), and a horizontal axis represents a hydrochloric acid concentration (in the drawing, represented by “HCl Concentration [% w/v]”). “w/v” means weight/volume, and represents a weight per unit volume. This has the same meaning in the following graphs.

With reference to FIG. 2, as the hydrochloric acid concentration is higher, the eluted fluorine ion concentration is also higher. However, when the hydrochloric acid concentration is higher than 10% w/v, the eluted fluorine ion concentration is saturated at 3,000 mg/L (3,000 ppm). This shows that only a constant amount of the sludge is dissolved with hydrochloric acid.

In the analysis of the sludge itself, it is shown that the sludge comprises salts of a divalent metal element with AlF⁴⁻ and AlF₅²⁻. The form of an Al—F complex is not only an anion such as AlF₃³⁻, AlF₅²⁻, and AlF₄⁻ but also a cation such as AlF²⁺. This leads to the following estimation.

The sludge is insoluble, but a slight amount of the sludge is eluted to a liquid phase. Specifically, anionic species such as AlF₄⁻ and AlF₅²⁻ are eluted from the sludge to the liquid phase. The sludge is difficult to be dissolved since an equilibration of this elution is achieved by the slight amount. Therefore, if the anionic species can be converted into cationic species such as AlF²⁺ and AlF₂⁺ immediately after elution from the sludge, the elution of the anionic species is continuously continued.

The cationic species such as AlF²⁺ and AlF₂⁺ do not form salts with divalent metal ions (Ba²⁺, Sr²⁺, Ca²⁺, and Mg²⁺) that are the same as the cations eluted from the sludge. Therefore, if the eluted anionic species can be continuously converted into cationic species, the divalent metal ions are also continuously eluted to the liquid phase. Accordingly, the sludge can be dissolved.

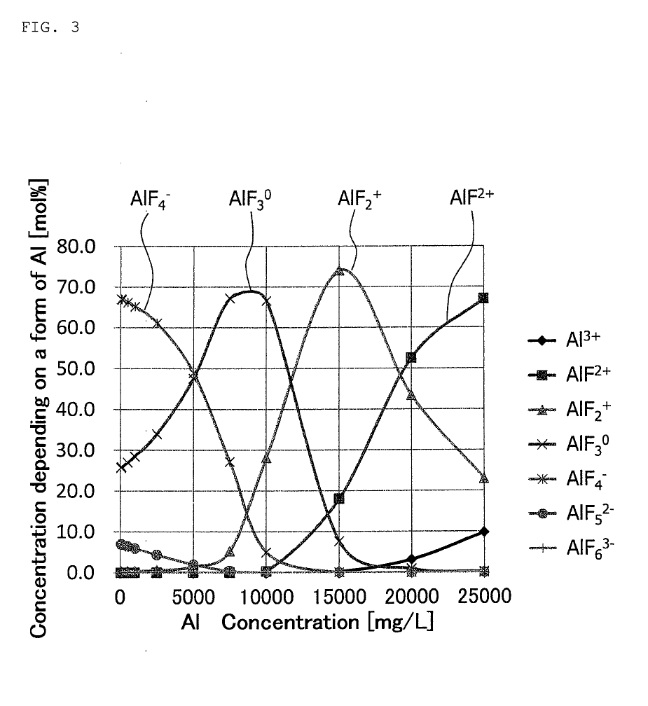

A condition where the cationic species such as AlF²⁺ and AlF₂⁺ take priority in a solution is determined by calculation (also referred to as speciation) of form of ionic species using each equilibration constant. For example, when the Al ion concentration was increased under a condition of a fluorine concentration of 20,000 mg/L and a pH of 1, the form of Al ion was determined to be any form of Al³⁺, AlF²⁺, AlF₂⁺, AlF₃°, AlF₅²⁻, and AlF₆³⁻. The results are shown in FIG. 3.

In FIG. 3, a vertical axis represents the existing concentration (mol %) of each form of Al, and a horizontal axis represents the Al ion concentration (mg/L). With reference to FIG. 3, AlF₄⁻ (anionic species) preferentially exists at an aluminum ion concentration of 5,000 mg/L or less. In a range of aluminum ion concentration of 5,000 to 12,000 mg/L, AlF₃ (neutral ion species) takes priority.

In a range of aluminum ion concentration of 12,000 to 18,000 mg/L, AlF₂⁺ (cationic ions) takes priority. In an aluminum ion concentration of 18,000 mg/L or more, AlF²⁺ takes priority. Therefore, when the Al ion concentration is increased, the Al—F complex becomes a cationic ion species. Accordingly, the sludge can be decomposed (dissolved).

On the basis of the above-described results, by adding hydrochloric acid and an aluminum chloride aqueous solution (AlCl₃.aq) as an Al³⁺ source to the sludge, the relationship between the aluminum chloride aqueous solution concentration and the eluted fluorine concentration was examined.

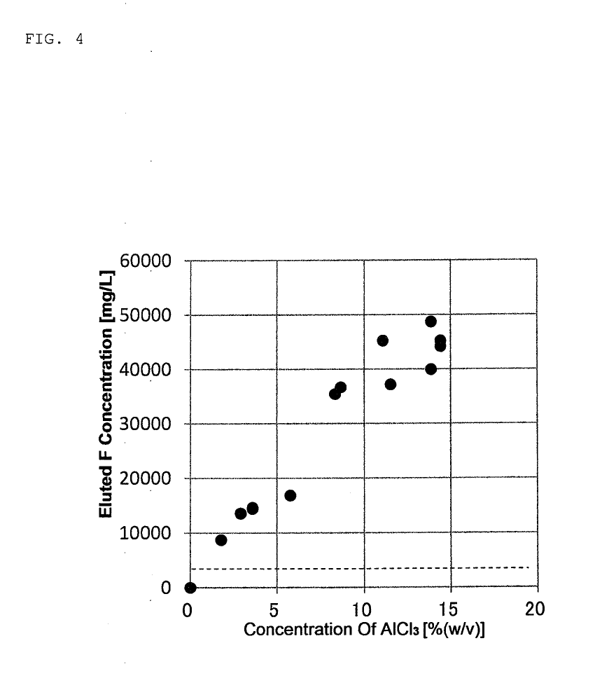

In an experiment, 1.0 g of Ba rich sludge was impregnated with 20 mL of an aluminum chloride aqueous solution with a concentration of 0 to 15 [% w/v], and the mixture was stirred for 12 hours while the liquid temperature was held at 30° C. The solution after the stirring was filtered through a filter of 0.22 μm, and the composition of the filtrate was analyzed. For the quantification of fluorine, ion chromatography was used. The results are shown in FIG. 4.

In FIG. 4, a vertical axis represents the eluted fluorine concentration (in the drawing, represented by “Eluted F Concentration [mg/L]”), and a horizontal axis represents the aluminum chloride aqueous solution concentration (in the drawing, represented by “AlCl₃ Concentration [% w/v]”).

With reference to FIG. 4, as the concentration of aluminum chloride is higher, the eluted fluorine ion concentration is higher, and the eluted fluorine ion concentration is not saturated until an aluminum chloride concentration reaches 15[% w/v]. In FIG. 4, a dotted line represents the eluted fluorine ion concentration in a case where only hydrochloric acid is used. This is a saturation value (about 3,000 [mg/L]) of the eluted fluorine ion concentration shown in FIG. 2.

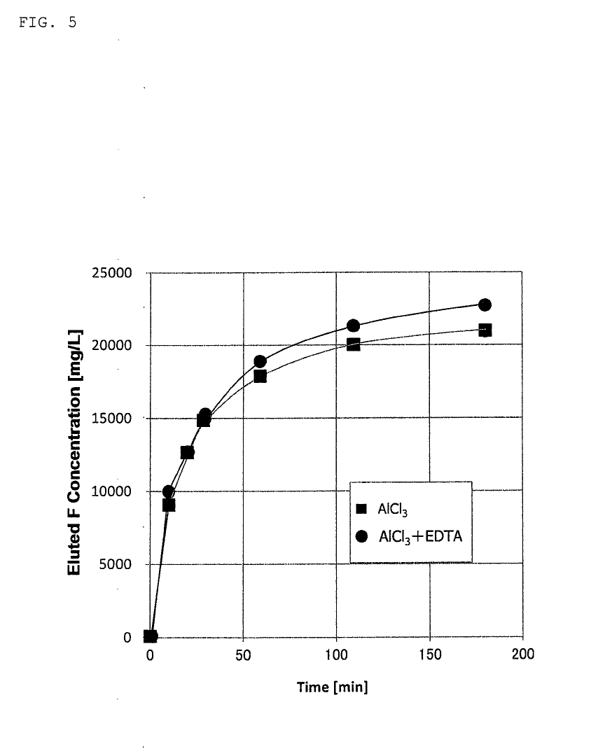

In order to experimentally confirm a sludge dissolution mechanism, a relationship between a solution in which ethylenediaminetetraacetic acid (EDTA) was added to an aluminum chloride aqueous solution and the eluted fluorine ion concentration was examined in FIG. 5. A solution in which EDTA was not added is also shown as a control.

In an experiment, 1.0 g of Ba rich sludge was impregnated with a solution in which the concentration of Al³⁺ was 25,000 mg/L, and the mixture was stirred while the liquid temperature was held at 30° C. The solution was sampled every predetermined time, and the eluted fluorine concentration was measured. As the solution in which EDTA was added, a solution in which EDTA with a concentration of 7,700 mg/L was further added to an aluminum chloride aqueous solution with a concentration of 25,000 mg/L was used. In general, the sludge is not dissolved with EDTA alone under an acidic condition. However, when a complex is formed with part of Al³⁺, the sludge can be dissolved, and a solid is not observed in the solution. Accordingly, part of Al³⁺ is chelated by EDTA.

In FIG. 5, a vertical axis represents the eluted fluorine concentration (in the drawing, represented by “Eluted F Concentration [mg/L]”), and a horizontal axis represents a time (min). Further, squares represent a case of only the aluminum chloride aqueous solution, and circles represent a case of further adding EDTA.

With reference to FIG. 5, whether EDTA exists or not makes no difference in the eluted fluorine ion concentration. In the case of further adding EDTA, a precipitate was observed. A component of the precipitate was examined to be 4H.EDTA. This is because Al³⁺ ions forming the complex with EDTA released EDTA and formed a complex with fluorine eluted from the sludge.

Therefore, it is shown that Al³⁺ is involved in the formation of the complex with fluorine eluted from the sludge. In consideration of progressing the elution of fluorine with time (progressing the elution of divalent metal ions such as barium, calcium, and magnesium), it is concluded that AlF2+ or AlF2+ is formed as a complex species.

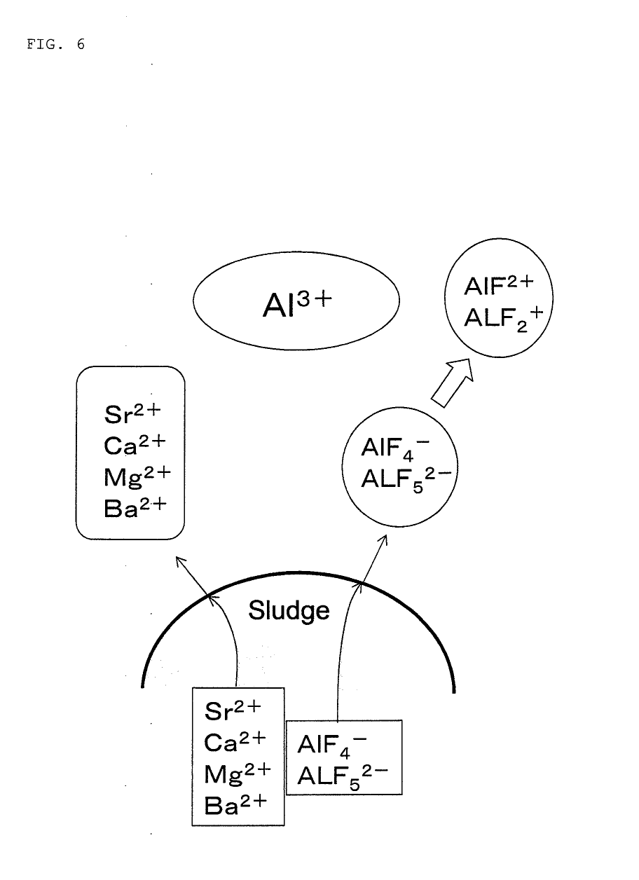

FIG. 6 shows a schematic view of a mechanism in which the sludge is dissolved with Al³⁺ ions. The sludge comprises salts of the divalent metal ions with anionic species such as AlF₄⁻ and AlF₅²⁻. The anionic species eluted from the sludge to the solution are converted into cationic species such as AlF²⁺ and AlF₂₊ in the presence of Al³⁺. As a result, the anionic species are continuously eluted from the sludge. The eluted cationic species do not form salts with the divalent metal ions. Therefore, the divalent metal ions are also continuously eluted from the sludge, and the sludge is thus dissolved.

Examples of the trivalent aluminum ion source include an aluminum nitrate aqueous solution and an aluminum sulfate aqueous solution. Whether the aqueous solutions can be also used as the aluminum ion source is confirmed.

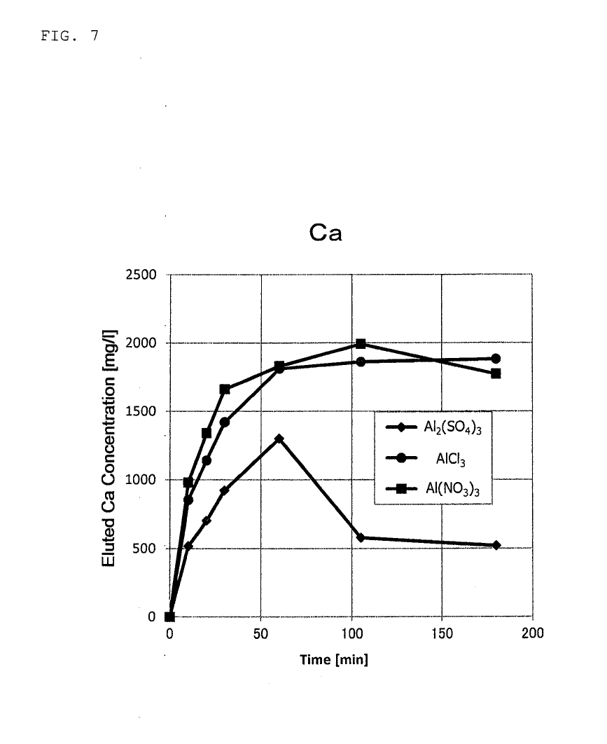

FIGS. 7 to 10 show a relationship of the eluted element concentration in a case of using the aluminum nitrate aqueous solution or the aluminum sulfate aqueous solution as the Al³⁺ source. In each graph, a vertical axis represents the concentration of eluted element (mg/L) and a horizontal axis represents a reaction time (min).

In an experiment, an aluminum chloride aqueous solution, an aluminum nitrate aqueous solution, and an aluminum sulfate aqueous solution that had an aluminum ion concentration of 40,000 mg/L were prepared. With 20 mL of each solution, 1.0 g of the sludge obtained from the Ba rich glass was impregnated. The mixture was stirred with the temperature of the solution held at 30° C. The solution was sampled every predetermined time, and filtered through a filter of 0.22 μm, and the solution after the filtration was measured by ICP-AES.

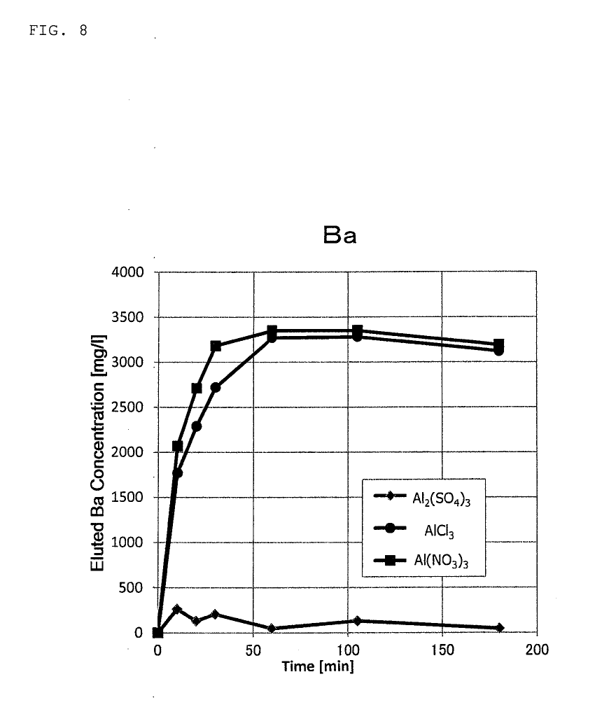

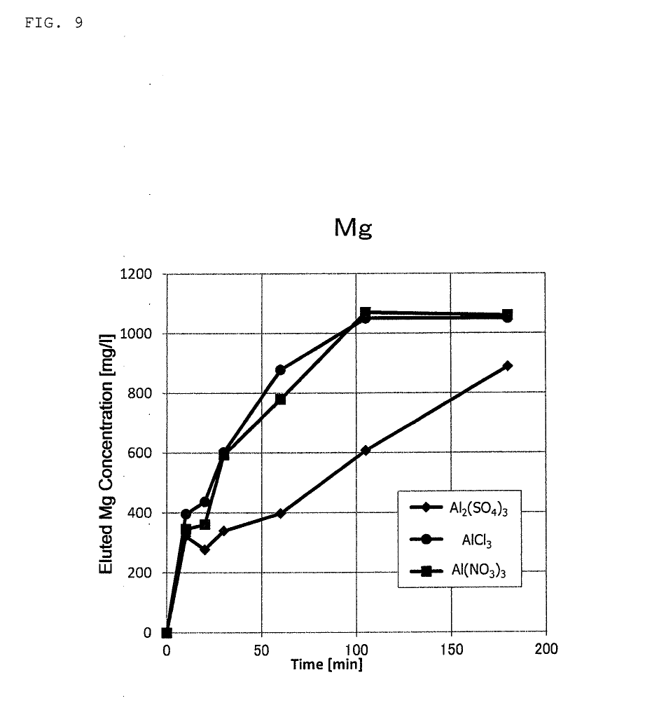

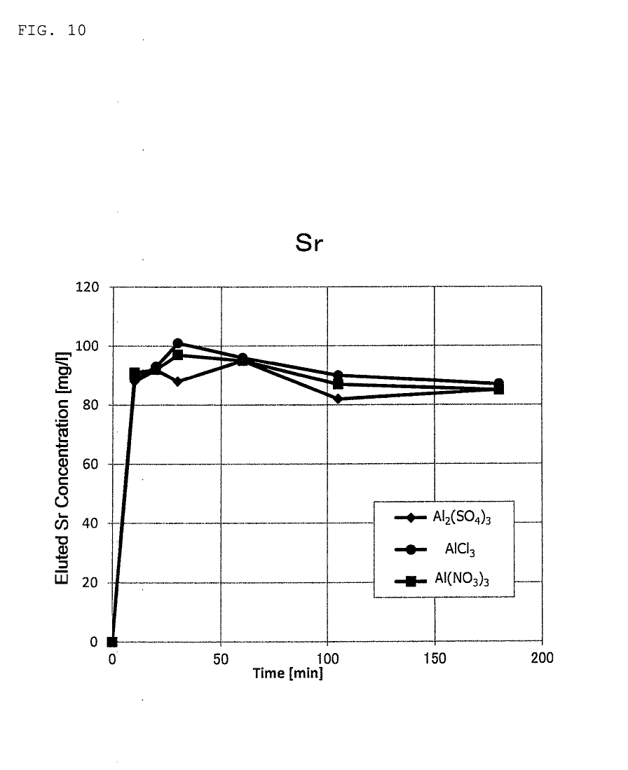

FIG. 7 shows the case of Ca, FIG. 8 shows the case of Ba, FIG. 9 shows the case of Mg, and FIG. 10 shows the case of Sr. For calcium of FIG. 7, barium of FIG. 8, and magnesium of FIG. 9, the elution amount in the aluminum sulfate aqueous solution was smaller than those in the aluminum nitrate aqueous solution and the aluminum chloride aqueous solution. This is because a byproduct of barium, calcium, or magnesium with sulfate ions was produced by using the aluminum sulfate aqueous solution. The byproduct was analyzed by XRD, and as a result, a compound mainly containing BaSO₄ was detected.

The sludge obtained from the Sr rich glass was subjected to the same experiment. In the aluminum sulfate aqueous solution, a byproduct of strontium, calcium, or magnesium with sulfate ions was produced. The elution amounts of strontium, calcium, and magnesium in the solution were small. The byproduct was analyzed by XRD, and as a result, a compound mainly containing SrSO₄ was detected. Therefore, it is shown that as the Al³⁺ source, the aluminum chloride aqueous solution and the aluminum nitrate aqueous solution are suitable.

Referring to FIG. 1 again, a method of washing the glass polishing device 10 using the washing liquid according to the present invention will be described. The polishing liquid is first drawn from the polishing device 10. The polishing liquid is drawn from all parts other than a tank and a pipe that store a new polishing liquid (not shown in the drawings). This is a liquid removing step. Next, the washing liquid is introduced into the polishing device 10. The washing liquid in a minimum amount that allows the shower unit 14 to be operated may be introduced into the polishing device 10. However, the washing liquid may be introduced in an amount that is equal to or more than that of the polishing liquid. This is because the polishing device 10 can be operated in the same manner as in a case of polishing the glass 90. This is an injection step.

The inside of the polishing device 10 is then washed. In the washing, the polishing device 10 is operated in the same manner as in the case of polishing the glass 90. This is because the washing liquid is circulated within the polishing device 10 and all parts that are brought into contact with the polishing liquid are washed. The shower unit 14 is also operated to spread the washing liquid to the insides of the storage unit 12, the filter 14f, and the pipe 14b. The washing may be performed with the washing liquid that is warmed to a liquid temperature of about 30 to 50° C. This is because the higher the reaction temperature is, the more dissolutions of the sludge by Al3+ is promoted. The reaction temperature needs to be, of course, equal to or lower than a temperature at which a material for a part with the sludge being fixed thereto in the polishing device 10 is not damaged. For this reason, a washing device may be provided with a humidifier (not shown). This is a washing step.

At last, the washing liquid is drawn. This is a liquid discharging step. After the liquid discharging step, the polishing liquid is introduced into the polishing device 10, and the glass 90 is polished again.

Between the liquid removing step and the injection step, the inside of the polishing device 10 may be water-washed with washing water. More specifically, it is desired that the washing water be injected into the polishing device 10 in which the polishing liquid is drawn (washing water injection step), the polishing device 10 be operated similarly to the washing step, and the washing water be spread to details of the polishing device 10 (washing water circulating step). After that, the washing water is drawn from the polishing device 10 (washing water discharging step). In the washing water discharging step, the washing water may be extruded by the washing liquid that is injected into the device in a latter injection step. Three steps including the washing water injection step, the washing water circulating step, and the washing water discharging step may be collectively referred to as a water washing step.

The washing water used herein is desirably pure water.

Washing water that does not contain at least Si is desired. The water washing step has an effect of extruding the polishing liquid remained in the pipe in the liquid removing step. If the polishing liquid containing SiF₆²⁻ ions remains in the polishing device, a gelled colloidal silica (SiO₂.xH₂O) may be produced by a reaction of Formula (1).

Al³⁺+SiF₆²⁻→SiO₂.xH₂O (1)

The gelled colloidal silica becomes a cause of clogging in small tube parts of the shower unit 14 and the like. Therefore, it is desirable that the water washing step be performed until ions such as SiF₆²⁻ ions are sufficiently decreased.

The liquid discharging step and a rinsing step of rinsing the inside of the polishing device 10 with water before introduction of the polishing liquid may be performed. If the washing liquid containing Al³⁺ after washing remains in the polishing device 10 in the liquid discharging step after the washing step, the concentration of aluminum ions in the polishing device 10 is increased during the introduction of the polishing liquid into the polishing device 10. Since the polishing liquid is rich in fluorine, aluminum ions remained after the washing are likely to be anionic species such as AlF₄⁻ and AlF₅²⁻ resulting in a cause of generating the sludge. Accordingly, when the rinsing step is performed, the concentration of the aluminum ions as the cause of the sludge can be decreased, and the generation of the sludge can be decreased.

In the rinsing step, a rinsing water is injected into the polishing device 10 (rinsing water injection step), and the polishing device 10 is operated to circulate the rinsing water into the polishing device 10 (rinsing water circulating step). Discharge of the rinsing water (rinsing water discharging step) after that is included. In the rinsing water discharging step, the rinsing water may be extruded by a polishing liquid injected in the next step.

As described above, the washing liquid for the glass polishing device according to the present invention allows the sludge produced during polishing of a glass using the polishing liquid containing hydrogen fluoride to be effectively removed. By the method of washing a glass polishing device according to the present invention, the sludge in the detailed parts in the polishing device can be removed. When the water washing step and the rinsing step are added, the generation of colloidal silica and the generation of a sludge immediately after further operation of the polishing device can be suppressed.

### INDUSTRIAL APPLICABILITY

The washing liquid and the washing method according to the present invention can be suitably used in washing of a glass polishing device for decreasing the thickness of a glass.

### REFERENCE SIGNS LIST

10 glass polishing device
12 storage unit
14 shower unit
14b pipe
14f filter
14p polishing liquid pump
16 nozzle
20 transporting means
90 glass

1. A washing liquid for dissolving a sludge containing aluminum and fluorine produced in a glass polishing device for polishing an alkali-free glass containing Ba and Sr, the washing liquid comprising an Al³⁺ ion and, as a source of the Al³⁺ ion, containing an aluminum chloride aqueous solution.

2. (canceled)

3. (canceled)

4. A method for washing a glass polishing device for polishing an alkali-free glass containing Ba and Sr, the method comprising:
a liquid removing step drawing a glass polishing liquid from the glass polishing device;
an injection step injecting a washing liquid containing an Al³⁺ ion supplying agent into the glass polishing device;
a washing step washing the glass polishing device with the washing liquid from the glass polishing device; and
a liquid discharging step drawing the washing liquid from the glass polishing device,
wherein the washing liquid contains an aluminum chloride aqueous solution as a source of the Al³⁺ ion.

5. The method for washing a glass polishing device according to claim 4 further comprising a water washing step washing the glass polishing device with washing water between the liquid removing step and the injection step.

6. The method for washing a glass polishing device according to claim 4 further comprising a rinsing step rinsing the glass polishing device with water, after the liquid discharging step.

7. (canceled)

8. (canceled)

9. (canceled)

10. (canceled)

11. (canceled)
